(19) United States
(12) Patent Application Publication
(10) Pub. No.: US 2014/0168962 A1
(43) Pub. Date: Jun. 19, 2014

(54) DIRECT-CURRENT LIGHT-EMITTING DIODE LAMP WITH POLARITY-HOLDING FUNCTION

(71) Applicant: Shih-Hsien Chang, (US)

(72) Inventor: Po-Nien KO, Taichung City (TW)

(73) Assignee: Shih-Hsien CHANG, Changhua County (TW)

(21) Appl. No.: 13/716,504

(22) Filed: Dec. 17, 2012

(51) Int. Cl. F21V 23/00

(52) U.S. Cl. CPC F21V 23/003
USPC 362/227

(57) ABSTRACT

A direct-current light-emitting diode lamp (DC LED lamp) with a polarity-holding function receives a DC driving voltage and the DC LED lamp includes at least one LED string and a polarity-holding circuit. The at least one LED string has a plurality of LEDs and each LED is connected in series to each other to form an anode terminal and a cathode terminal. The polarity-holding circuit is electrically connected to the anode terminal and the cathode terminal of the LED string. The polarity-holding circuit receives the DC driving voltage and holds the polarity of the DC driving voltage, thus driving the LED string in forward bias.

### BACKGROUND

1. Technical Field

The present disclosure relates generally to a direct-current light-emitting diode lamp, and more particularly to a direct-current light-emitting diode lamp with a polarity-holding function.

2. Description of Related Art

Because the light-emitting diodes (LEDs) have the advantages of high brightness, low operating voltage, small power consumption, easy to match with ICs, simple drive, long life, and so on, LEDs are widely applied in light source of lighting lamps or backlight source of portable electronic produces.

Reference is made to FIG. 1 which is a schematic circuit block diagram of installing a driver inside the LED lamp according to related art. The LED lamp 10A has a LED driver 30A and at least one LED string 20A. The LED lamp 10A is supplied power by an external AC voltage V_{ac}. The external AC voltage V_{ac} is converted by the LED driver 30A into a DC driving voltage V_{LED} for driving the LED string 20A. The above-mentioned design of driving the LED string 20 has the following characteristics:

1. No polarity issue. Because the LED lamp 10A is directly electrically connected to the external AC voltage V_{ac}, the LED lamp 10A can be forwardly connected or reversely connected to the external AC voltage V_{ac}. Users do not need to recognize the polarity of the LED lamp 10A when detaching or installing the LED lamp 10A. Hence, the LED lamp 10A will not be damaged even if the LED lamp 10A is operated in the reverse connection; and

2. There is a safety issue. Because the level of the external AC voltage V_{ac} belongs to the dangerous level and further the LED lamp 10A is directly electrically connected to the external AC voltage V_{ac}, users possibly receive injures during detaching or installing the LED lamp 10A.

Reference is made to FIG. 2 which is a schematic circuit block diagram of installing a driver outside the LED lamp according to the related art. The LED lamp 10A has at least one LED string 20A. The LED lamp 10A is connected to a LED driver 30A and then the LED driver 30A is supplied power by an external AC voltage V_{ac}. The external AC voltage V_{ac} is converted into a DC driving voltage V_{LED} by the LED driver 30A for driving the LED string 20A. The above-mentioned design of driving the LED string 20A has the following characteristics:

1. There is a polarity issue. Because the DC driving voltage V_{LED} is outputted by converting the external AC voltage V_{ac} by the LED driver 30A, users need to recognize the polarity of the LED lamp 10A to match the polarity of the DC driving voltage V_{LED} when detaching or installing the LED lamp 10A. Hence, the LED lamp 10A will be damaged if the LED lamp 10A is operated in the reverse connection; and

2. There is a safety issue. Because the DC driving voltage V_{LED} is outputted by converting the external AC voltage V_{ac} by the LED driver 30A, users possibly receive injures during detaching or installing the LED lamp 10A once the level of the DC driving voltage V_{LED} is high.

Reference is made to FIG. 3 which is a schematic circuit block diagram of driving a plurality of LED lamps according to the related art. A LED driver 30A is used to convert an external AC voltage V_{ac} into multiple DC driving voltages V_{LED} for driving multiple LED lamps 10_1A˜10_nA. At least two wires are used when each of the LED lamps 10_1A˜10_nA is electrically connected to the LED driver 30A, thus increasing wire costs and installation time when the amount of the LED lamps 10_1A˜10_nA is increased.

Accordingly, it is desirable to provide a DC LED lamp with a polarity-holding function with a polarity-holding circuit. The polarity-holding circuit receives a DC driving voltage and holds the polarity of the DC driving voltage to drive the DC LED lamp in forward bias, thus overcoming the polarity issue and the safety issue, reducing wire costs, and saving installation time.

### SUMMARY

An object of the present disclosure is to provide a direct-current light-emitting diode lamp with a polarity-holding function receiving a direct-current driving voltage to solve the above-mentioned problems. Accordingly, the direct-current light-emitting diode lamp includes at least one light-emitting diode string and a polarity-holding circuit. The at least one light-emitting diode string has a plurality of light-emitting diodes, each of the light-emitting diodes is connected in series to each other to form an anode terminal and a cathode terminal. The polarity-holding circuit is electrically connected to the anode terminal and the cathode terminal of the light-emitting diode string. The polarity-holding circuit receives the direct-current driving voltage and holds the polarity of the direct-current driving voltage, thus driving the light-emitting diode string in forward bias.

Another object of the present disclosure is to provide a direct-current light-emitting diode lamp with a polarity-holding function receiving a direct-current driving voltage to solve the above-mentioned problems. Accordingly, the direct-current light-emitting diode lamp includes at least one light-emitting diode string, a direct-current driver, and a polarity-holding circuit. The at least one light-emitting diode string has a plurality of light-emitting diodes, each of the light-emitting diodes is connected in series to each other to form an anode terminal and a cathode terminal. The direct-current driver is electrically connected to the anode terminal and the cathode terminal of the light-emitting diode string and is configured to provide a direct-current driving voltage to drive the light-emitting diode string. The polarity-holding circuit is electrically connected to the direct-current driver. The polarity-holding circuit is configured to receive the external direct-current voltage and hold the polarity of the external direct-current voltage to correctly supply power to the direct-current light-emitting diode lamp, thus driving the light-emitting diode string in forward bias by the direct-current driving voltage.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a schematic circuit block diagram of installing a driver inside the LED lamp according to related art;

FIG. 2 is a schematic circuit block diagram of installing a driver outside the LED lamp according to the related art;

FIG. 3 is a schematic circuit block diagram of driving a plurality of LED lamps according to the related art;

FIG. 4 is a circuit block diagram of a DC LED lamp with a polarity-holding function according to the present disclosure;

FIG. 5A is a circuit diagram of operating a polarity-holding circuit under a forward connection of the DC LED lamp according to the present disclosure;

FIG. 5B is a circuit diagram of operating a polarity-holding circuit under a reverse connection of the DC LED lamp according to the present disclosure;

FIG. 6 is a circuit block diagram of supplying power to the DC LED lamp by an external AC voltage according to the present disclosure;

FIG. 7A is a circuit block diagram of supplying power to a plurality of DC LED lamps according to a first embodiment of the present disclosure;

FIG. 7B is a circuit block diagram of supplying power to a plurality of DC LED lamps according to a second embodiment of the present disclosure;

FIG. 8 is a circuit block diagram of a DC LED lamp with a polarity-holding function according to the present disclosure;

FIG. 9A is a circuit diagram of operating a polarity-holding circuit under a forward connection of the DC LED lamp according to the present disclosure;

FIG. 9B is a circuit diagram of operating a polarity-holding circuit under a reverse connection of the DC LED lamp according to the present disclosure; and

FIG. 10 is a circuit block diagram of supplying power to the DC LED lamp by an external AC voltage according to the present disclosure.

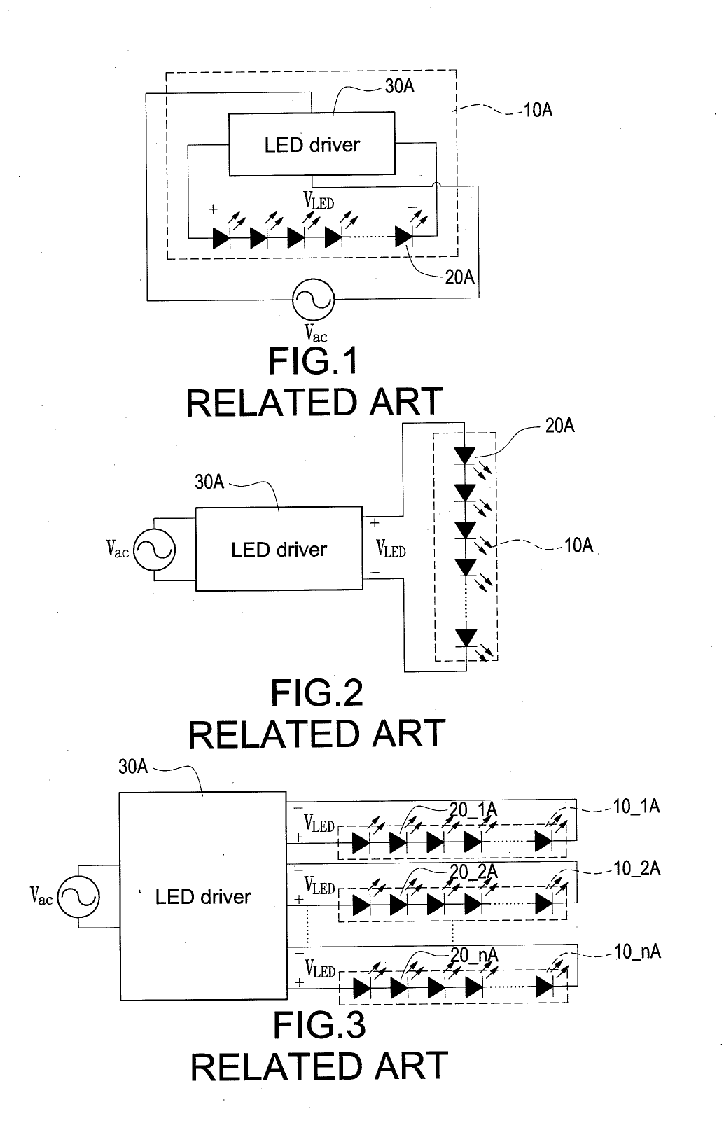

### DETAILED DESCRIPTION

Reference will now be made to the drawing figures to describe the present disclosure in detail.

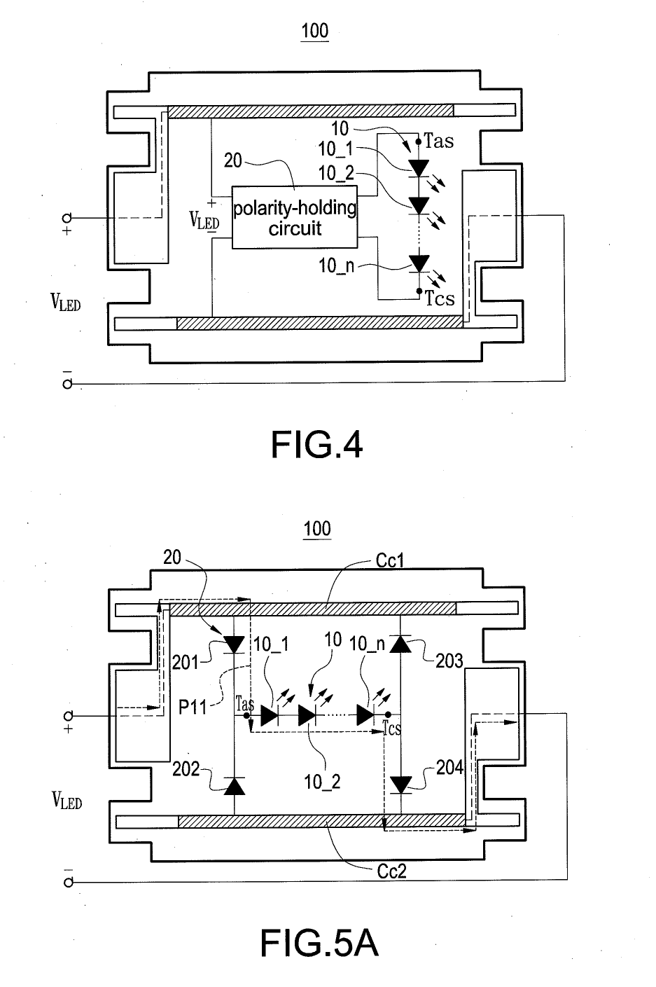

Reference is made to FIG. 4 which is a circuit block diagram of a direct-current light-emitting diode lamp (DC LED lamp) with a polarity-holding function according to the present disclosure. The DC LED lamp 100 with the polarity-holding function receives a direct-current (DC) driving voltage W_{ED}. The DC LED lamp 100 includes at least one light-emitting diode string (LED string) 10 and a polarity-holding circuit 20. Especially, the LED string 10 and the polarity-holding circuit 20 are installed inside the DC LED lamp 100. In particular, the single LED string is exemplified for further demonstration. However, the embodiments are only exemplified but are not intended to limit the scope of the disclosure. The number and structure of series and parallel connections of the LED strings can be designed according to the practical needs. The LED string 10 has a plurality of light-emitting diodes (LEDs) 10_1˜10_n. Each of the LEDs 10_1˜10_n is connected in series to each other to form an anode terminal Tas and a cathode terminal Tcs. The polarity-holding circuit 20 is electrically connected to the anode terminal Tas and the cathode terminal Tcs of the LED string 10. The polarity-holding circuit 20 receives the DC driving voltage V_{LED} and holds the polarity of the DC driving voltage V_{LED}, thus driving the LED string 10 in forward bias. The detailed operation of the DC LED lamp 100 with the polarity-holding function will be described hereinafter as follows.

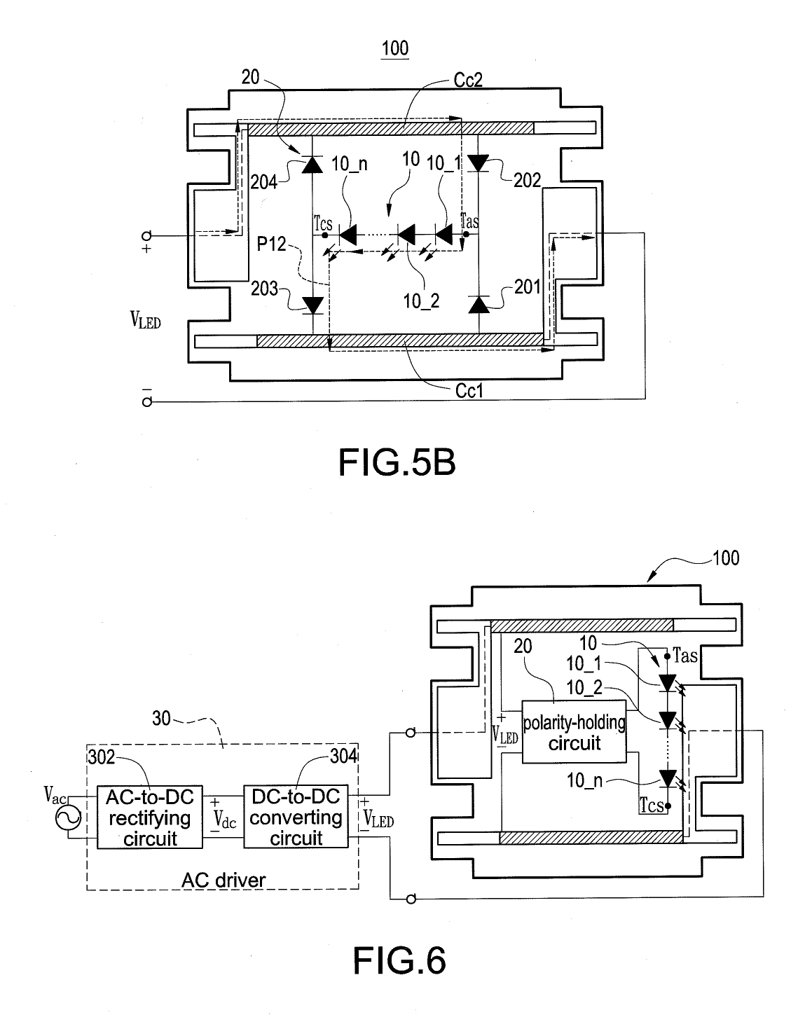

Reference is made to FIG. 5A which is a circuit diagram of operating a polarity-holding circuit under a forward connection of the DC LED lamp according to the present disclosure. The polarity-holding circuit 20 can be a bridge rectifying circuit. The bridge rectifying circuit has four diodes, namely, a first diode 201, a second diode 202, a third diode 203, and a fourth diode 204. A cathode of the first diode 201 is connected to a cathode of the second diode 202 and then connected to the anode terminal Tas of the LED string 10. An anode of the third diode 203 is connected to an anode of the fourth diode 204 and then connected to the cathode terminal Tcs of the LED string 10. An anode of the first diode 201 is connected to a cathode of the third diode 203 to form a first connecting point Cc1. An anode of the second diode 202 is connected to a cathode of the fourth diode 204 to form a second connecting point Cc2. In particular, the bridge rectifying circuit is exemplified as the polarity-holding circuit 20; however, the embodiment is only exemplified but is not intended to limit the scope of the disclosure. Various substitutions and modifications of the polarity-holding circuit 20 are intended to be embraced within the scope of the present disclosure.

When the polarity-holding circuit 20 is operated under a forward connection of the DC LED lamp 100, that is, the first connecting point Cc1 and the second connecting point Cc2 of the polarity-holding circuit 20 are electrically connected to a positive polarity and a negative polarity of the DC driving voltage V_{LED}, respectively, so that the DC driving voltage V_{LED} is provided to drive the LED string 10 through a first current path P11 sequentially formed by the positive polarity of the DC driving voltage V_{LED}, the first connecting point Cc1, the first diode 201, the anode terminal Tas of the LED string 10, the cathode terminal Tcs of the LED string 10, the fourth diode 204, the second connecting point Cc2, and the negative polarity of the DC driving voltage V_{LED}.

Reference is made to FIG. 5B which is a circuit diagram of operating a polarity-holding circuit under a reverse connection of the DC LED lamp according to the present disclosure. When the polarity-holding circuit 20 is operated under a reverse connection of the DC LED lamp 100, that is, the first connecting point Cc1 and the second connecting point Cc2 of the polarity-holding circuit 20 are electrically connected to the negative polarity and the positive polarity of the DC driving voltage V_{LED}, respectively, so that the DC driving voltage V_{LED} is provided to drive the LED string 10 through a second current path P12 sequentially formed by the positive polarity of the DC driving voltage V_{LED}, the second connecting point Cc2, the second diode 202, the anode terminal Tas of the LED string 10, the cathode terminal Tcs of the LED string 10, the third diode 203, the first connecting point Cc1, and the negative polarity of the DC driving voltage V_{LED}.

Accordingly, when the DC LED lamp 100 is forwardly connected or reversely connected to the DC driving voltage V_{LED}, the forward conduction of the first diode 201 and the fourth diode 204 of the polarity-holding circuit 20 and the forward condition of the second diode 202 and the third diode 203 of the polarity-holding circuit 20 hold the polarity of the DC driving voltage V_{LED}, thus driving the LED string 10 in forward bias.

In addition, based on safe consideration of operating the DC LED lamp 100, the DC driving voltage V_{LED} meets the standard of safe voltage. That is, in the present disclosure, the DC driving voltage V_{LED} is less than or equal to 60 volts. The DC LED lamp 100 is a low-voltage DC lamp and the DC driving voltage V_{LED} is corresponding to the required voltage of driving the DC LED lamp 100.

Reference is made to FIG. 6 which is a circuit block diagram of supplying power to the DC LED lamp by an external AC voltage according to the present disclosure. The DC driving voltage V_{LED} is provided from an alternating-current (AC) driver 30. The AC driver 30 at least has an AC-to-DC rectifying circuit 302 and a DC-to-DC converting circuit 304. The AC-to-DC rectifying circuit 302 receives an external alternating-current (AC) voltage V_{ac} and convert the external AC voltage V_{ac} into a direct-current (DC) voltage V_{dc}. The DC-to-DC converting circuit 304 receives the DC voltage V_{dc} and converts the DC voltage V_{dc} into the DC driving voltage V_{LED}, thus driving the DC LED lamp 100.

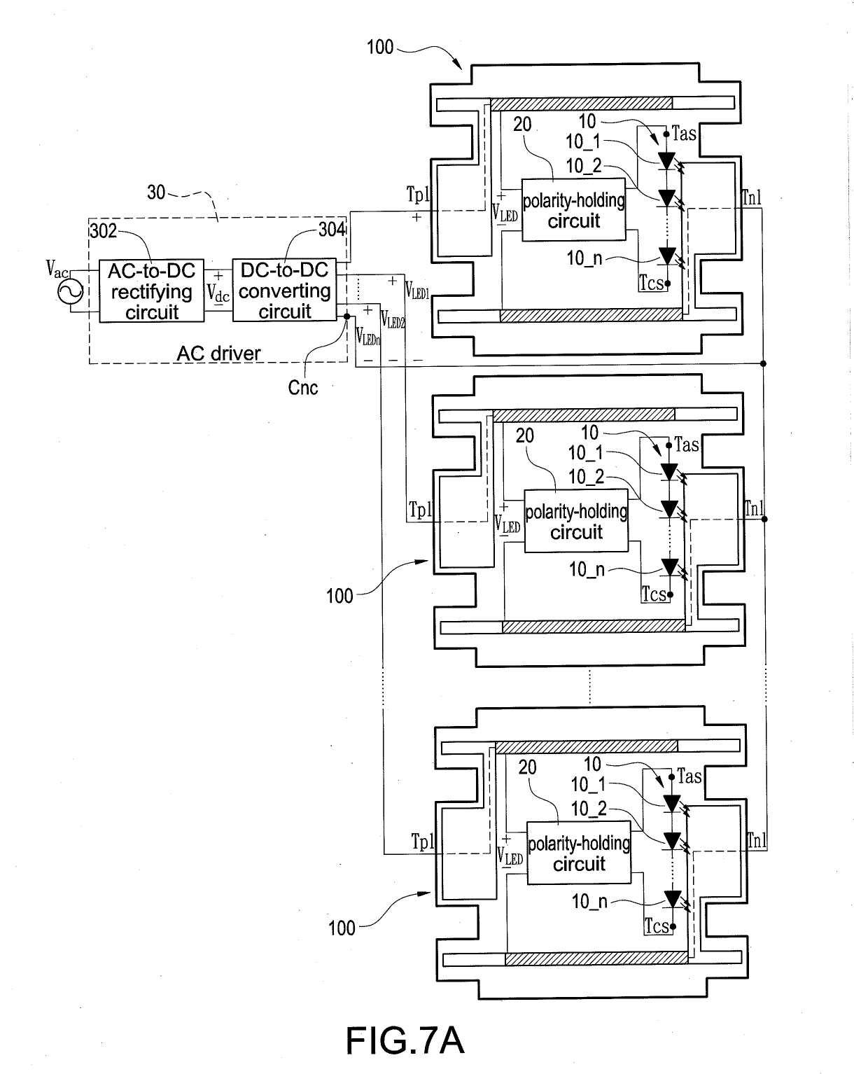

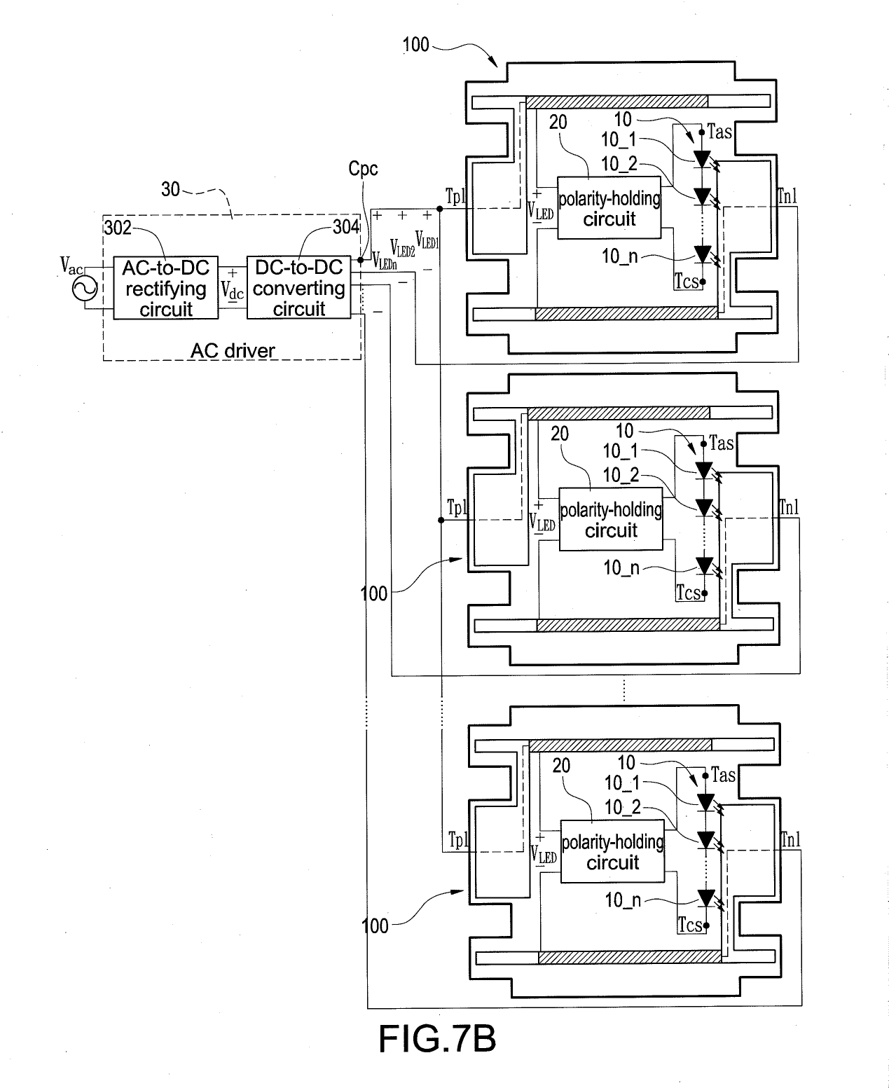

Reference is made to FIG. 7A and FIG. 7B are circuit block diagrams of supplying power to a plurality of DC LED lamps according to a first embodiment and a second embodiment of the present disclosure, respectively. As shown in FIG. 7A, each of the DC LED lamps 100 has a positive terminal Tp1 and a negative terminal Tn1 when the amount of the DC LED lamp 100 is plural. Also, each of the DC LED lamps 100 correspondingly receives a DC driving voltage V_{LED1}˜V_{LEDn}. The positive terminal Tp1 of each DC LED lamp 100 is correspondingly electrically connected to a positive polarity of each DC driving voltage V_{LED1}˜V_{LEDn}. A negative polarity of each DC driving voltage V_{LED1}˜V_{LEDn} is connected to each other to provide a negative common connecting point Cnc, and then the negative common connecting point Cnc is electrically connected to the negative terminals Tn1 of the DC LED lamps 100, respectively. Especially, the DC LED lamps 100 can be electrically connected in parallel via a common wire according to installation locations thereof or other considerations. That is, the negative terminals Tn1 of the DC LED lamps 100 are electrically connected to each other and then connected to the negative common connecting point Cnc of the DC driving voltages V_{LED1}˜V_{LEDn}, thus reducing wire costs and saving installation time. Similarly, as shown in FIG. 7B, each of the DC LED lamps 100 has a positive terminal Tp1 and a negative terminal Tn1 when the amount of the DC LED lamp 100 is plural. Also, each of the DC LED lamps 100 correspondingly receives a DC driving voltage V_{LED1}˜V_{LEDn}. The negative terminal Tn1 of each DC LED lamp 100 is correspondingly electrically connected to a negative polarity of each DC driving voltage V_{LED1}˜V_{LEDn}. A positive polarity of each DC driving voltage V_{LED1}˜V_{LEDn} is connected to each other to provide a positive common connecting point Cpc, and then the positive common connecting point Cpc is electrically connected to the positive terminals Tp1 of the DC LED lamp 100, respectively. Especially, the DC LED lamps 100 can be electrically connected in parallel via a common wire according to installation locations thereof or other considerations. That is, the positive terminals Tp1 of the DC LED lamps 100 are electrically connected to each other and then connected to the positive common connecting point Cpc of the DC driving voltages V_{LED1}˜V_{LEDn}, thus reducing wire costs and saving installation time.

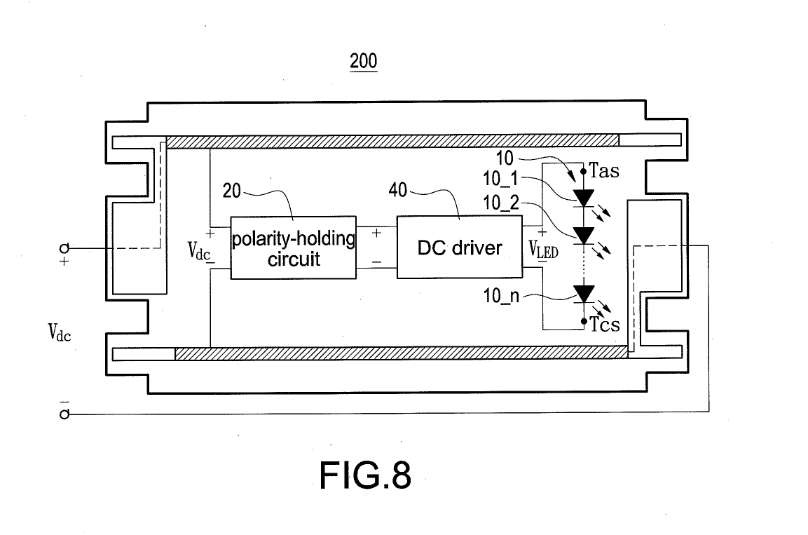

Reference is made to FIG. 8 which is a circuit block diagram of a DC LED lamp with a polarity-holding function according to the present disclosure. The DC LED lamp 200 with the polarity-holding function receives an external direct-current (DC) voltage V_{dc}. The DC LED lamp 100 includes at least one light-emitting diode string (LED string) 10, a direct-current (DC) driver 40, and a polarity-holding circuit 20. Especially, the LED string 10, the polarity-holding circuit 20, and the DC driver 40 are installed inside the DC LED lamp 200. In particular, the single LED string is exemplified for further demonstration. However, the embodiments are only exemplified but are not intended to limit the scope of the disclosure. The number and structure of series and parallel connections of the LED strings can be designed according to the practical needs. The LED string 10 has a plurality of light-emitting diodes (LEDs) 10_1˜10_n. Each of the LEDs 10_1˜10_n is connected in series to each other to form an anode terminal Tas and a cathode terminal Tcs. The DC driver 40 is electrically connected to the anode terminal Tas and the cathode terminal Tcs of the LED string 10 to provide a direct-current (DC) driving voltage V_{LED} to drive the LED string 10. The polarity-holding circuit 20 is electrically connected to the DC driver 40. The polarity-holding circuit 20 receives the external DC voltage V_{dc} and holds the polarity of the external DC voltage V_{dc} to correctly supply power to the DC LED lamp 200, thus driving the LED string 10 in forward bias by the DC driving voltage V_{LED}. The detailed operation of the DC LED lamp 200 with the polarity-holding function will be described hereinafter as follows.

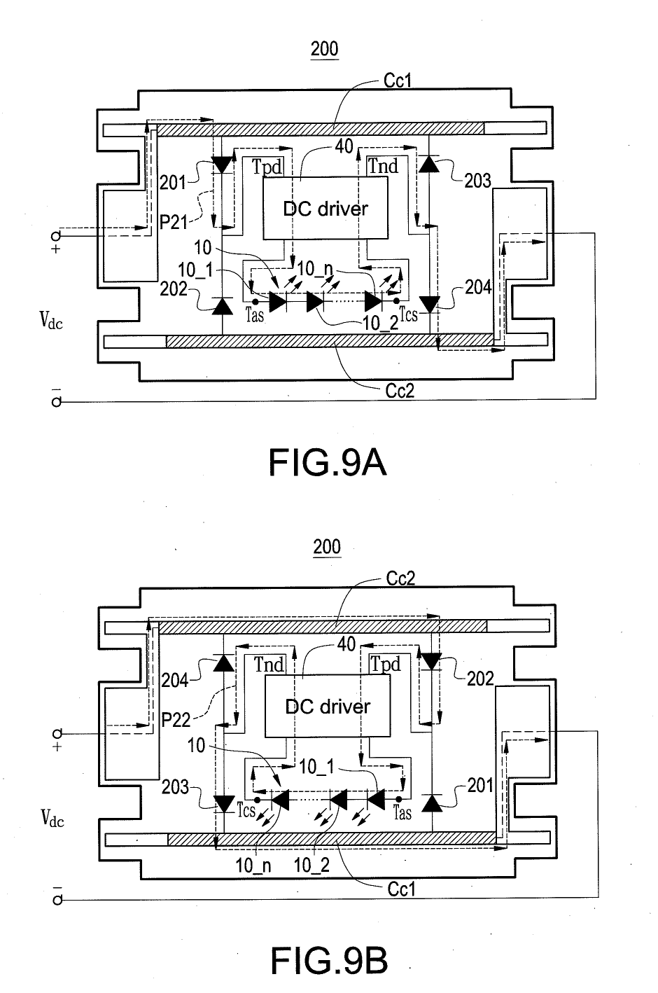

Reference is made to FIG. 9A which is a circuit diagram of operating a polarity-holding circuit under a forward connection of the DC LED lamp according to the present disclosure. The polarity-holding circuit 20 can be a bridge rectifying circuit. The bridge rectifying circuit has four diodes, namely, a first diode 201, a second diode 202, a third diode 203, and a fourth diode 204. A cathode of the first diode 201 is connected to a cathode of the second diode 202 and then connected to a positive input terminal Tpd of the DC driver 40. An anode of the third diode 203 is connected to an anode of the fourth diode 204 and then connected to a negative input terminal Tnd of the DC driver 40. An anode of the first diode 201 is connected to a cathode of the third diode 203 to form a first connecting point Cc1. An anode of the second diode 202 is connected to a cathode of the fourth diode 204 to form a second connecting point Cc2. In particular, the bridge rectifying circuit is exemplified as the polarity-holding circuit 20; however, the embodiment is only exemplified but is not intended to limit the scope of the disclosure. Various substitutions and modifications of the polarity-holding circuit 20 are intended to be embraced within the scope of the present disclosure.

When the polarity-holding circuit 20 is operated under a forward connection of the DC LED lamp 200, that is, the first connecting point Cc1 and the second connecting point Cc2 of the polarity-holding circuit 20 are electrically connected to a positive polarity and a negative polarity of the external DC voltage V_{dc}, respectively, so that the external DC voltage V_{dc} is provided to supply power to the DC LED lamp 200 and the DC driving voltage V_{LED} is provided to drive the LED string 10 through a first current path P21 sequentially formed by the positive polarity of the external DC voltage V_{dc}, the first connecting point Cc1, the first diode 201, the positive input terminal Tpd of the DC driver 40, the anode terminal Tas of the LED string 10, the cathode terminal Tcs of the LED string 10, the negative input terminal Tnd of the DC driver 40, the fourth diode 204, the second connecting point Cc2, and the negative polarity of the external DC voltage V_{dc}.

Reference is made to FIG. 9B which is a circuit diagram of operating a polarity-holding circuit under a reverse connection of the DC LED lamp according to the present disclosure. When the polarity-holding circuit 20 is operated under a reverse connection of the DC LED lamp 200, that is, the first connecting point Cc1 and the second connecting point Cc2 of the polarity-holding circuit 20 are electrically connected to the negative polarity and the positive polarity of the external DC voltage V_{dc}, respectively, so that the external DC voltage V_{dc} is provided to supply power to the DC LED lamp 200 and the DC driving voltage V_{LED} is provided to drive the LED string 10 through a second current path P22 sequentially formed by the positive polarity of the external DC voltage V_{dc}, the second connecting point Cc2, the second diode 202, the positive input terminal Tpd of the DC driver 40, the anode terminal Tas of the LED string 10, the cathode terminal Tcs of the LED string 10, the negative input terminal Tnd of the DC driver 40, the third diode 203, the first connecting point Cc1, and the negative polarity of the external DC voltage V_{dc}.

Accordingly, when the DC LED lamp 200 is forwardly connected or reversely connected to the external DC voltage V_{dc}, the forward conduction of the first diode 201 and the fourth diode 204 of the polarity-holding circuit 20 and the forward condition of the second diode 202 and the third diode 203 of the polarity-holding circuit 20 hold the polarity of the external DC voltage V_{dc} to always correctly supply power to the DC LED lamp 200, thus driving the LED string 10 in forward bias by the DC driving voltage V_{LED}.

In addition, based on safe consideration of operating the DC LED lamp 200, the DC driving voltage V_{LED} meets the standard of safe voltage. That is, in the present disclosure, the DC driving voltage V_{LED} is less than or equal to 60 volts. The DC LED lamp 200 is a low-voltage DC lamp and the DC driving voltage V_{LED} is corresponding to the required voltage of driving the DC LED lamp 200.

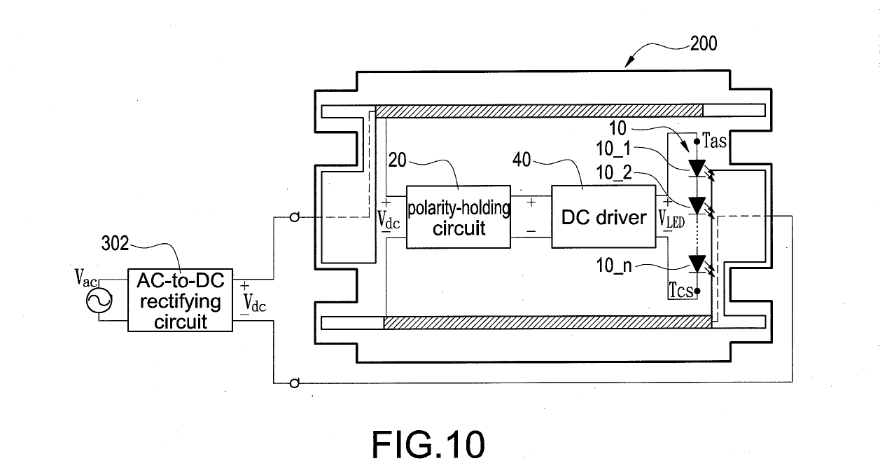

Reference is made to FIG. 10 which is a circuit block diagram of supplying power to the DC LED lamp by an external AC voltage according to the present disclosure. The external DC voltage V_{dc} is provided from an AC-to-DC rectifying circuit 302. The AC-to-DC rectifying circuit 302 receives an external alternating-current (AC) voltage V_{ac} and converts the external AC voltage V_{ac} into the external DC voltage V_{dc}, thus driving the DC LED lamp 200.

In conclusion, the present disclosure has following advantages:

1. The polarity-holding circuit is provided to receive the DC voltage and holds the polarity of the DC voltage to correctly supply power to the DC LED lamp and driving the LED string in forward bias by the DC driving voltage, thus preventing the LED lamp from damage due to the incorrect polarity connection;

2. The DC LED lamp is designed as a low-voltage DC lamp and the DC driving voltage meets the standard of safe voltage, namely, the DC driving voltage is less than or equal to 60 volts so as to avoid causing casualties during detaching or installing the DC LED lamp; and

3. The multiple DC LED lamps can be electrically connected in parallel via a common wire when these LED lamps are simultaneously driven by individual DC driving voltages, thus reducing wire costs and saving installation time.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A direct-current light-emitting diode lamp with a polarity-holding function receiving a direct-current driving voltage, the direct-current light-emitting diode lamp comprising:
at least one light-emitting diode string having a plurality of light-emitting diodes, each of the light-emitting diodes connected in series to each other to form an anode terminal and a cathode terminal; and
a polarity-holding circuit electrically connected to the anode terminal and the cathode terminal of the light-emitting diode string;
wherein the polarity-holding circuit is configured to receive the direct-current driving voltage and hold the polarity of the direct-current driving voltage, thus driving the light-emitting diode string in forward bias.

2. The direct-current light-emitting diode lamp in claim 1, wherein the polarity-holding circuit is a bridge rectifying circuit; the bridge rectifying circuit has four diodes, namely, a first diode, a second diode, a third diode, and a fourth diode; a cathode of the first diode is connected to a cathode of the second diode and connected to the anode terminal of the light-emitting diode string; an anode of the third diode is connected to an anode of the fourth diode and connected to the cathode terminal of the light-emitting diode string; an anode of the first diode is connected to a cathode of the third diode to form a first connecting point; an anode of the second diode is connected to a cathode of the fourth diode to form a second connecting point.

3. The direct-current light-emitting diode lamp in claim 2, wherein the first connecting point and the second connecting point of the polarity-holding circuit are electrically connected to a positive polarity and a negative polarity of the direct-current driving voltage, respectively, so that the direct-current driving voltage is provided to drive the light-emitting diode string through a current path sequentially formed by the positive polarity of the direct-current driving voltage, the first connecting point, the first diode, the anode terminal of the light-emitting diode string, the cathode terminal of the light-emitting diode string, the fourth diode, the second connecting point, and the negative polarity of the direct-current driving voltage.

4. The direct-current light-emitting diode lamp in claim 2, wherein the first connecting point and the second connecting point of the polarity-holding circuit are electrically connected to a negative polarity and a positive polarity of the direct-current driving voltage, respectively, so that the direct-current driving voltage is provided to drive the light-emitting diode string through a current path sequentially formed by the positive polarity of the direct-current driving voltage, the second connecting point, the second diode, the anode terminal of the light-emitting diode string, the cathode terminal of the light-emitting diode string, the third diode, the first connecting point, and the negative polarity of the direct-current driving voltage.

5. The direct-current light-emitting diode lamp in claim 1, wherein the direct-current driving voltage is less than or equal to 60 volts; the direct-current light-emitting diode lamp is a low-voltage direct-current lamp and the direct-current driving voltage is corresponding to the required voltage of driving the direct-current light-emitting diode lamp.

6. The direct-current light-emitting diode lamp in claim 5, wherein the direct-current driving voltage is provided from an alternating-current driver; the alternating-current driver at least has an AC-to-DC rectifying circuit and a DC-to-DC converting circuit; the AC-to-DC rectifying circuit is configured to receive an external alternating-current voltage and convert the external alternating-current voltage into a direct-current voltage; the DC-to-DC converting circuit is configured to receive the direct-current voltage and convert the direct-current voltage into the direct-current driving voltage, thus driving the direct-current light-emitting diode lamp.

7. The direct-current light-emitting diode lamp in claim 3, wherein the amount of the direct-current light-emitting diode lamp is plural, each direct-current light-emitting diode lamp has a positive terminal and a negative terminal and each direct-current light-emitting diode lamp is configured to correspondingly receive a direct-current driving voltage; wherein a positive polarity of each direct-current driving voltage is electrically connected to the positive terminal of the direct-current light-emitting diode lamp, respectively, and negative polarities of the direct-current driving voltages are electrically connected to form a negative common connecting point and the negative common connecting point is electrically connected to the negative terminals of the direct-current light-emitting diode lamps, respectively.

8. The direct-current light-emitting diode lamp in claim 4, wherein the amount of the direct-current light-emitting diode lamp is plural, each direct-current light-emitting diode lamp has a positive terminal and a negative terminal and each direct-current light-emitting diode lamp is configured to correspondingly receive a direct-current driving voltage; wherein a positive polarity of each direct-current driving voltage is electrically connected to the positive terminal of the direct-current light-emitting diode lamp, respectively, and negative polarities of the direct-current driving voltages are electrically connected to form a negative common connecting point and the negative common connecting point is electrically connected to the negative terminals of the direct-current light-emitting diode lamps, respectively.

9. The direct-current light-emitting diode lamp in claim 3, wherein the amount of the direct-current light-emitting diode lamp is plural, each direct-current light-emitting diode lamp has a positive terminal and a negative terminal and each direct-current light-emitting diode lamp is configured to correspondingly receive a direct-current driving voltage; wherein a negative polarity of each direct-current driving voltage is electrically connected to the negative terminal of the direct-current light-emitting diode lamp, respectively, and positive polarities of the direct-current driving voltages are electrically connected to form a positive common connecting point and the positive common connecting point is electrically connected to the positive terminals of the direct-current light-emitting diode lamps, respectively.

10. The direct-current light-emitting diode lamp in claim 4, wherein the amount of the direct-current light-emitting diode lamp is plural, each direct-current light-emitting diode lamp has a positive terminal and a negative terminal and each direct-current light-emitting diode lamp is configured to correspondingly receive a direct-current driving voltage; wherein a negative polarity of each direct-current driving voltage is electrically connected to the negative terminal of the direct-current light-emitting diode lamp, respectively, and positive polarities of the direct-current driving voltages are electrically connected to form a positive common connecting point and the positive common connecting point is electrically connected to the positive terminals of the direct-current light-emitting diode lamps, respectively.

11. A direct-current light-emitting diode lamp with a polarity-holding function receiving an external direct-current voltage, the direct-current light-emitting diode lamp comprising:
at least one light-emitting diode string having a plurality of light-emitting diodes, each of the light-emitting diodes connected in series to each other to form an anode terminal and a cathode terminal;
a direct-current driver electrically connected to the anode terminal and the cathode terminal of the light-emitting diode string and configured to provide a direct-current driving voltage to drive the light-emitting diode string; and
a polarity-holding circuit electrically connected to the direct-current driver;
wherein the polarity-holding circuit is configured to receive the external direct-current voltage and hold the polarity of the external direct-current voltage to correctly supply power to the direct-current light-emitting diode lamp, thus driving the light-emitting diode string in forward bias by the direct-current driving voltage.

12. The direct-current light-emitting diode lamp in claim 11, wherein the polarity-holding circuit is a bridge rectifying circuit; the bridge rectifying circuit has four diodes, namely, a first diode, a second diode, a third diode, and a fourth diode; a cathode of the first diode is connected to a cathode of the second diode and connected to a positive input terminal of the direct-current driver; an anode of the third diode is connected to an anode of the fourth diode and connected to a negative input terminal of the direct-current driver; an anode of the first diode is connected to a cathode of the third diode to form a first connecting point; an anode of the second diode is connected to a cathode of the fourth diode to form a second connecting point.

13. The direct-current light-emitting diode lamp in claim 12, wherein the first connecting point and the second connecting point of the polarity-holding circuit are electrically connected to a positive polarity and a negative polarity of the direct-current driving voltage, respectively, so that the external direct-current voltage is provided to supply power to the direct-current light-emitting diode lamp and the direct-current driving voltage is provided to drive the light-emitting diode string through a current path sequentially formed by the positive polarity of the external direct-current voltage, the first connecting point, the first diode, the positive input terminal of the direct-current driver, the anode terminal of the light-emitting diode string, the cathode terminal of the light-emitting diode string, the negative input terminal of the direct-current driver, the fourth diode, the second connecting point, and the negative polarity of the external direct-current voltage.

14. The direct-current light-emitting diode lamp in claim 12, wherein the first connecting point and the second connecting point of the polarity-holding circuit are electrically connected to a negative polarity and a positive polarity of the direct-current driving voltage, respectively, so that the external direct-current voltage is provided to supply power to the direct-current light-emitting diode lamp and the direct-current driving voltage is provided to drive the light-emitting diode string through a current path sequentially formed by the positive polarity of the external direct-current voltage, the second connecting point, the second diode, the positive input terminal of the direct-current driver, the anode terminal of the light-emitting diode string, the cathode terminal of the light-emitting diode string, the negative input terminal of the direct-current driver, the third diode, the first connecting point, and the negative polarity of the external direct-current voltage.

15. The direct-current light-emitting diode lamp in claim 11, wherein the direct-current driving voltage is less than or equal to 60 volts; the direct-current light-emitting diode lamp is a low-voltage direct-current lamp and the direct-current driving voltage is corresponding to the required voltage of driving the direct-current light-emitting diode lamp.

16. The direct-current light-emitting diode lamp in claim 15, wherein the external direct-current voltage is provided from an AC-to-DC rectifying circuit; the AC-to-DC rectifying circuit is configured to receive an external alternating-current voltage and convert the external alternating-current voltage into the external direct-current voltage, thus driving the direct-current light-emitting diode lamp.
